(19) United States
(12) Patent Application Publication
(10) Pub. No.: US 2021/0285285 A1
(43) Pub. Date: Sep. 16, 2021

(54) Security Screen Mounting System and Method Therefor

(71) Applicants: Don Roberts, Tupelo, MS (US); James Wilford Roberts, Saltillo, MS (US)

(72) Inventors: Don Roberts, Tupelo, MS (US); James Wilford Roberts, Saltillo, MS (US)

(21) Appl. No.: 17/333,627

(22) Filed: May 28, 2021

Related U.S. Application Data
(63) Continuation of application No. 17/036,503, filed on Sep. 29, 2020.
Application No. 17/036,503 is a continuation-in-part of application No. 15/833,675, filed on Dec. 6, 2017, now Pat. No. 10,837,228.

(51) Int. Cl. E06B 9/52

(52) U.S. Cl. CPC E06B 9/52; E06B 2009/527

(57) ABSTRACT

A mounting system and method for security screens for use with double-hung windows and other windows having an integral screen track is disclosed. The mounting system and method according to the present invention reduces materials cost for manufacture of security screens while improving aesthetics of the installation, and permits installation of security screens either at the construction site or during window manufacture, while preserving the window manufacturer's warranty.

### CROSS-REFERENCE TO RELATED APPLICATIONS

Continuation-in-part of currently pending U.S. patent application Ser. No. 17/036,503 filed Sep. 29, 2020, which is a continuation-in-part of U.S. patent application Ser. No. 15/833,675 filed Dec. 6, 2017, now U.S. Pat. No 10,837,228.

### BACKGROUND OF THE INVENTION

Security screens are a popular option to protect windows of businesses and homes from unauthorized intrusion such as burglars breaking the window to gain access, hail or other weather conditions, and other types of damage. Many commonly installed windows are made from materials such as “vinyl” (poly vinyl chloride, or PVC) or fiberglass that due to their relative strength in comparison to materials such as aluminum or wood, are not suitable for using mechanical fasteners such as screws to attach the security screen directly to the window. Also, direct attachment to the window itself, regardless of the material the window is made from, would cause damage such as punctures that could produce leaks and could void the window manufacturer's warranty. Consequently, existing systems and methods for installing security screens attach the screens to the exterior wall surrounding the window opening, either directly, or using spacers to build out around the window to provide clearance for the installation of the screen in circumstances where the window has not been installed recessed or flush relative to the wall surface. Security screens attached to the wall surrounding the window opening must thus be as large as, or often larger, than the window they are to protect, which is both aesthetically undesirable and increases manufacturing cost for the screens due to increasing the amount of materials required for their construction. A need therefore exists for a security screen mounting system and method which will not cause damage to the window that could void the window manufacturer's warranty, reduces manufacturing cost for the security screen, and improves the aesthetics of the installed screens by not hiding the window entirely behind an oversized security screen.

### REFERENCE NUMBERS

100 Window frame

### 110 Header

112 Left jamb
114 Right jamb

### 116 Sill

120 Screen track
200 Security screen (center hinged)
220 Screen panels
222 Fixed screen panel
224 Working screen panel
240 Connecting hinge

### 242 Screen

244 Screen retaining strip

### 246 Weatherstripping

### 250 Latch

300 Mounting rail (wide)
310 Mounting rail (narrow)

### 400 Fasteners

410 Hole covers

### BRIEF DESCRIPTION OF THE DRAWINGS

FIG. 1 is an exploded oblique front elevation view of a hinged security screen in closed position illustrating a mounting method according to an embodiment of the invention.

FIG. 2 is an assembled oblique front elevation view of a hinged security screen in open position illustrating a mounting method according to an embodiment of the invention.

FIG. 3 is an assembled cross-sectional plan view of the hinged security screen of FIG. 2 sectioned along line i-i and illustrating a mounting method according to an embodiment of the invention.

FIG. 4 is an exploded oblique front elevation view of a hinged security screen in closed position illustrating a mounting method according to an embodiment of the invention.

FIG. 5 is an assembled oblique front elevation view of a hinged security screen in open position illustrating a mounting method according to an embodiment of the invention.

FIG. 6 is an assembled cross-sectional plan view of the hinged security screen of FIG. 5 sectioned along line ii-ii and illustrating a mounting method according to an embodiment of the invention.

### DETAILED DESCRIPTION OF THE DRAWINGS

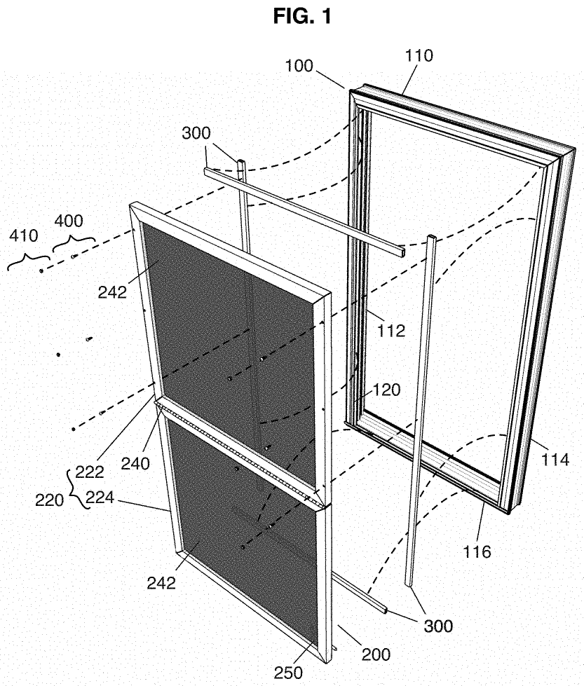

FIG. 1 is an exploded oblique front elevation view of a hinged security screen in closed position illustrating a mounting method according to an embodiment of the invention. For windows having an integral screen track 120 as part of the exterior portion of the window frame 100, which would include most double-hung windows, a security screen 200 can be sized to fit between the integral screen track 120 of the left jamb 112 and the integral screen track 120 of the right jamb 114. A plurality of mounting rails 300, sized and configured to fit within the integral screen track 120 of the window frame 100 are inserted in the integral screen track 120 and sized to the lengths of portions of the integral screen track 120, such as the lengths of the integral screen track 120 of the left jamb 112, the integral screen track 120 of the right jamb 114, and the integral screen track 120 of the header 110.

The lengths of the mounting rails 300 inserted in the integral screen track 120 of the left jamb 112 and the integral screen track 120 of the right jamb 114 may be shortened to accommodate the width of the mounting rail 300 inserted into the integral screen track 120 of the header 110, so that the ends of the mounting rail 300 inserted into the integral screen track 120 of the header 110 rest atop the mounting rails 300 inserted in the integral screen track 120 of the left jamb 112 and the integral screen track 120 of the right jamb 114. The security screen 200 of this embodiment of the invention consists of a plurality of screen panels 220 dividing the space between the opposing sides of the integral screen track 120, the plurality of screen panels 220 joined by at least one connecting hinge 240. In an exemplary embodiment, as shown, two screen panels 220 are joined by a horizontal connecting hinge 240; one of the screen panels 220 being a fixed screen panel 222, and the other a working screen panel 224.

The fixed screen panel 222 is attached to the plurality of mounting rails 310 using fasteners 400, such as screws, and in an preferred embodiment the screws are self-tapping screws which are inserted into pre-drilled holes in the fixed screen panel 222 and driven into the mounting rails 310 from the exterior side. In a preferred embodiment, the pre-drilled holes in the fixed screen panel 222 are concealed by hole covers 410 following installation of the fasteners 400. A working screen panel 224 is pivotably mounted to the fixed screen panel 222 by a connecting hinge 240, or other pivoting attachment means. This allows the working screen panel 224 of the security screen 200 to be pivoted open in the event access or egress through the window is needed, such as during an emergency.

Optionally, and as shown in the exemplary embodiment illustrated in FIG. 1, the lengths of the mounting rails 300 inserted in the integral screen track 120 of the left jamb 112 and the integral screen track 120 of the right jamb 114 may be shortened further to accommodate a mounting rail 300 whose ends are inserted beneath the mounting rails 300 inserted in the integral screen track 120 of the left jamb 112 and the integral screen track 120 of the right jamb 114, and spanning between them across the sill 116. During installation, this optional mounting rail 300 across the sill 116 may first be positioned by inserting its ends into the bottom portion of the integral screen track 120 of the left jamb 112 and the integral screen track 120 of the right jamb 114. Next, or if no mounting rail 300 across the sill 116 is used, a mounting rail 300 is inserted into the integral screen track 120 of the header 110. The mounting rail 300 inserted in the integral screen track 120 of the header 110 is held in place as mounting rails 300 are then inserted into the integral screen tracks 170 of the left jamb 112 and the right jamb 114, completing the installation of the plurality of mounting rails 300. It should be understood that the optional mounting rail 300 across the sill 116, if used, may be installed either before or after the mounting rail 300 inserted in the integral screen track 120 of the header 110, and that the mounting rails 300 inserted into the integral screen track 120 of the left jamb 112 and the integral screen screen track 120 of the right jamb 114 may installed in either order, but that the mounting rails 300 inserted into the integral screen track 120 of the left jamb 112 and the integral screen screen track 120 of the right jamb 114 must be installed last, following installation of the mounting rail 300 inserted in the integral screen track 120 of the header 110 and the mounting rail 300 across the sill 116, if used. Following completion of the installation of the mounting rails 300, the security screen 200 may then be attached to the mounting rails 300 as previously described.

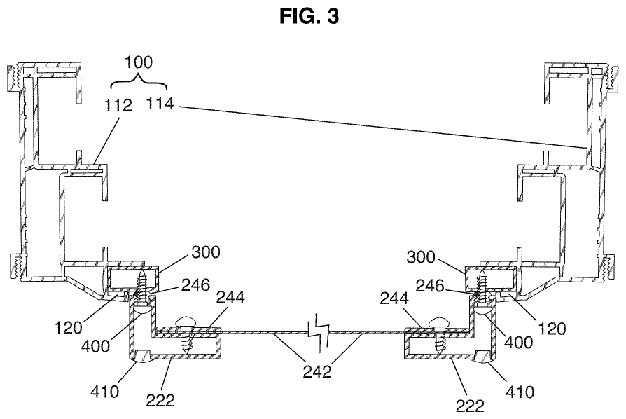

In a preferred embodiment, each of the plurality of mounting rails 300 have a width greater than the depth of the integral screen track 120 into which they are inserted (see also FIG. 3), and extend inwardly from the integral screen track 120 of the window frame, providing both a exterior-facing surface for the fixed screen panel 222 to be mounted to, and a stop against which the working screen panel 224 can rest when closed. This additional width of the mounting rails 300 also makes installation easier by providing exposed handholds and a raised surface to tap against, and structurally strengthens the mounting rails to support the weight of the security screen 200. It should be noted that the plurality of mounting rails 300 inserted in the integral screen track 120 of the window frame 100 are not attached to the window frame 100, but are held in place by their close fit relative to each other, their attachment to the fixed screen panel 222, or their relative positions within the integral screen track 120. The mounting rails 300 may be made of any suitable rigid material, such as metal, wood, polymer or composite materials, and in a preferred embodiment are metal tubing having a substantially rectangular cross section, such as aluminum tubing. Although four-sided hollow rectangular tubing is shown as the mounting rails 300, “U”-channel or solid bar stock may also be used, and bolts or machine screws could be used for the fasteners 400 attaching the fixed screen panel 222 to mounting rails 300 having threaded holes. If desired, a bead of construction adhesive may be applied to the plurality of mounting rails 300 prior to installation in the integral screen track to further strengthen the installation. A latching means, such as a latch 250 or barrel bolt, located at the side of the working screen panel 224 opposite to the connecting hinge 240 or other pivotable mounting means, may be used to reversibly secure the working screen panel 224 to the window frame 100 to prevent opening the working screen panel 224 until released from the interior side of the window. In a preferred embodiment, the latch 250 is a single-point latch as disclosed in U.S. Pat. No. 6,176,041. For clarity of illustration, only the window frame 100 is illustrated, and the sashes of the window being protected are not shown.

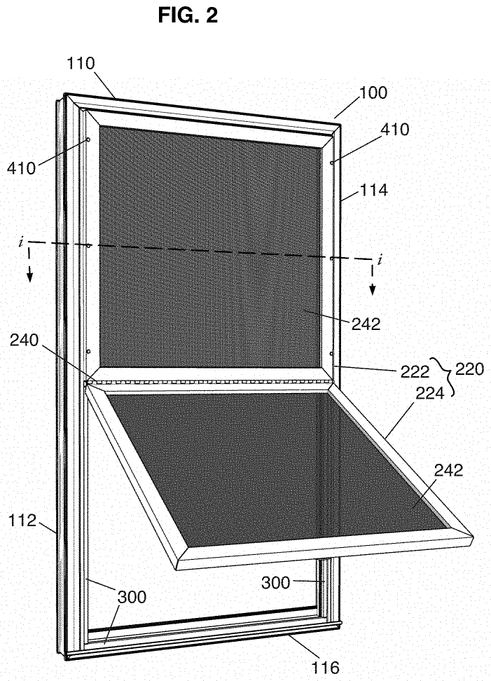

FIG. 2 is an assembled oblique front elevation view of a hinged security screen in open position illustrating a mounting method according to an embodiment of the invention. For windows having an integral screen track 120 as part of the exterior portion of the window frame 100, which would include most double-hung windows, a security screen 200 can be sized to fit between the integral screen track 120 in the left jamb 112 and the integral screen track 120 in the right jamb 114. The security screen 200 according to the present invention is smaller in size than prior art security screens relative to the window to be protected and the mounting method according to the present invention does not require a mounting flange, reducing materials requirements for construction and manufacture of the security screen 200. In a preferred embodiment, the screen panels 220 of the security screen 200 are pre-attached to the connecting hinge 240, and the fixed screen panel 222 pre-drilled to accept the fasteners 400 and hole covers 410.

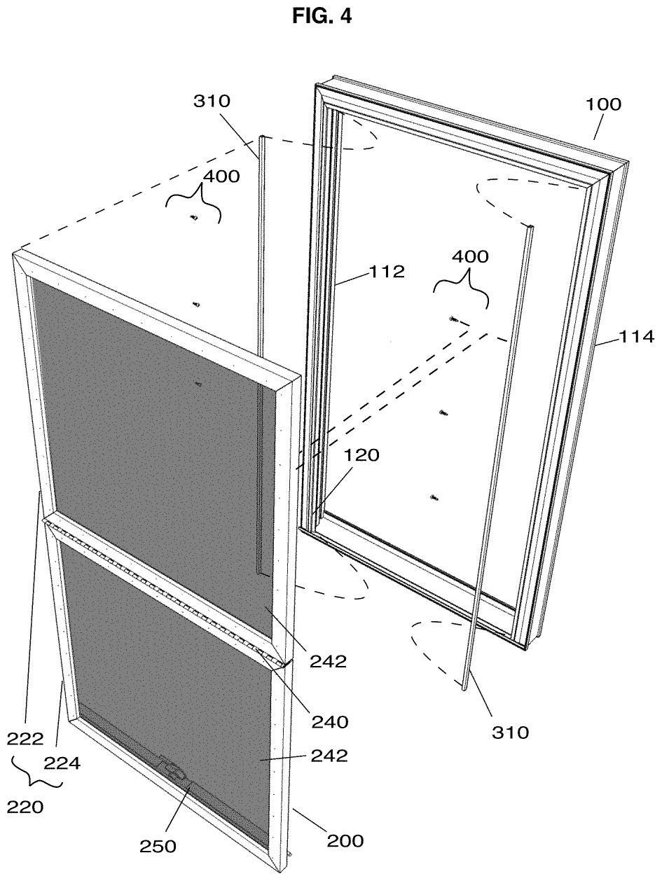

Provided that a window has the necessary integral screen track 120, installation of security screens 200 on double-hung windows according to the method of the present invention may be done in the field after window installation, or alternatively can be done at the factory during window manufacture. Installation of security screens at the factory during window manufacture is another advantage of the present invention, and can greatly simplify installation at the construction site when compared to installing windows and security screens as separate steps. While the security screen 200 shown in the embodiment of the invention illustrated in FIGS. 1-3 is not readily installed from the interior side of the window, due to a lack of access to the fasteners 400 from the interior side, a modification, as illustrated by the embodiment of the invention depicted in FIGS. 4-6, will permit the security screen 200 to be installed from the interior side. For clarity of illustration, only the window frame 100 is illustrated, and the sashes of the window being protected are not shown.

FIG. 3 is an assembled cross-sectional plan view of the hinged security screen of FIG. 2 sectioned along line i-i and illustrating a mounting method according to an embodiment of the invention. In a preferred embodiment, each of the plurality of mounting rails 300, such as those inserted into the integral screen track 120 of the left jamb 112 and the integral screen track 120 of the right jamb 114 have a width greater than the depth of the integral screen track 120 into which they are inserted, and extend inwardly from the integral screen track 120 of the window frame, providing both a structure for the fixed screen panel 222 to be mounted to, and a stop against which the working screen panel 224 can rest when closed. The fixed screen panel 222 is attached to the plurality of mounting rails 300 using fasteners 400, such as screws, and in an preferred embodiment the screws are self-tapping screws which are inserted into pre-drilled holes in the fixed screen panel 222 and driven into the mounting rails 300 from the exterior side of the window. In a preferred embodiment, the pre-drilled holes in the fixed screen panel 222 are concealed by hole covers 410 following installation of the fasteners 400. In a preferred embodiment, the screen panels 220 are made of metal, such as extruded aluminum, the connecting hinge 240 is a steel piano hinge, and the hole covers 410 are also made of metal, such as aluminum, though they could also be made from any suitable plastic material, such as PVC. As known in the art, screen retaining strips 244 may be used to attach the screen 242 to the screen panels 220, and the screen panels 220 may include weatherstripping 246 on the side contacting the plurality of mounting rails 300. In the embodiment of the invention illustrated in FIGS. 1-3, the fasteners 400 are driven through the weatherstripping 246. In a preferred embodiment, most of the visible parts, including the security screen panels 220, screen 242, connecting hinge 240, and mounting rails 300 are powder-coated for appearance and durability. For clarity of illustration, only the window frame 100 is illustrated, and the sashes of the window being protected are not shown.

FIG. 4 is an exploded oblique front elevation view of a hinged security screen in closed position illustrating a mounting method according to an embodiment of the invention. According to another embodiment of the invention, for windows having an integral screen track 120 as part of the window frame 100, which would include most double-hung windows, a security screen 200 having a connecting hinge 240 can be sized to fit between the integral screen track 120 in the left jamb 112 and the integral screen track 120 in the right jamb 114. The security screen 200 of this embodiment of the invention consists of a plurality of screen panels 220 dividing the space between the opposing sides of the integral screen track 120, the plurality of screen panels 220 joined by at least one connecting hinge 240. In an exemplary embodiment, as shown, two screen panels 220 are joined by a horizontal connecting hinge 240. A plurality of mounting rails 310, sized and configured to fit within the integral screen track 120 of the window frame 100 are inserted in the integral screen track 120 and sized to the length of a portion of the integral screen track 120, such as the length of the integral screen track 120 of the left jamb 112 and the integral screen track 120 of the right jamb 114.

A fixed screen panel 222 is attached to the plurality of mounting rails 310 using fasteners 400, such as screws, and in an preferred embodiment the screws are self-tapping screws which are inserted into pre-drilled holes in the fixed screen panel 222 and driven into the mounting rails 310. A working screen panel 224 is pivotably mounted to the fixed screen panel 222 by a connecting hinge 240, or other pivoting attachment means. This allows the working screen panel 224 of the security screen 200 to be pivoted open in the event access or egress through the window is needed, such as during an emergency. A latching means, such as a latch 250 or barrel bolt, located at the side of the working screen panel 224 opposite to the connecting hinge 240 or other pivotable mounting means, may be used to reversibly secure the working screen panel 224 to the window frame 100 to prevent opening the working screen panel 224 until released from the interior side of the window. In a preferred embodiment, the latch 250 is a single-point latch as disclosed in U.S. Pat. No. 6,176,041.

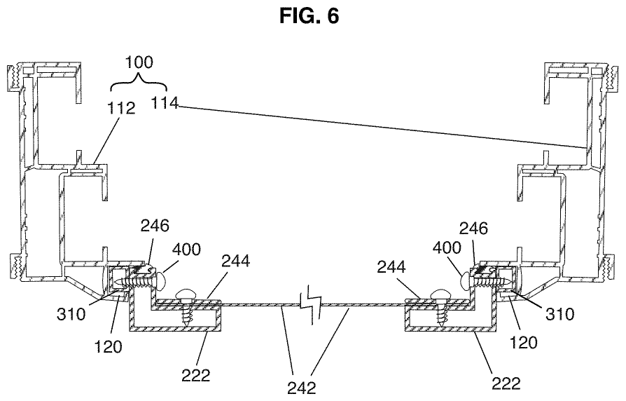

In a preferred embodiment, and as illustrated in FIGS. 4-6, each of the mounting rails 310 have a width equal to the depth of the integral screen track 120 into which they are inserted (see also FIG. 6), while the screen panels 220 have the same profile and are the same size as those shown in the embodiment of the invention illustrated in FIGS. 1-3, but are mounted slightly farther towards the interior side of the window frame. This enables the embodiment of the invention illustrated in FIGS. 4-6 to be installed from the interior side of the window. The fasteners 400 used to attach the security screen 200 to the plurality of mounting rails 310 in this embodiment of the invention are on the interior side (see also FIG. 6), and not readily accessible or visible from the exterior side of the security screen 200 once the security screen 200 is installed. This lack of readily visible fasteners 400, such as screws, on the exterior side of the screen both enhances aesthetic appearance of the installation, and prevents access from the exterior side of the security screen 200 to the fasteners 400 attaching the security screen 200 to the mounting rails 300 within the integral screen track 120 of the window frame 100.

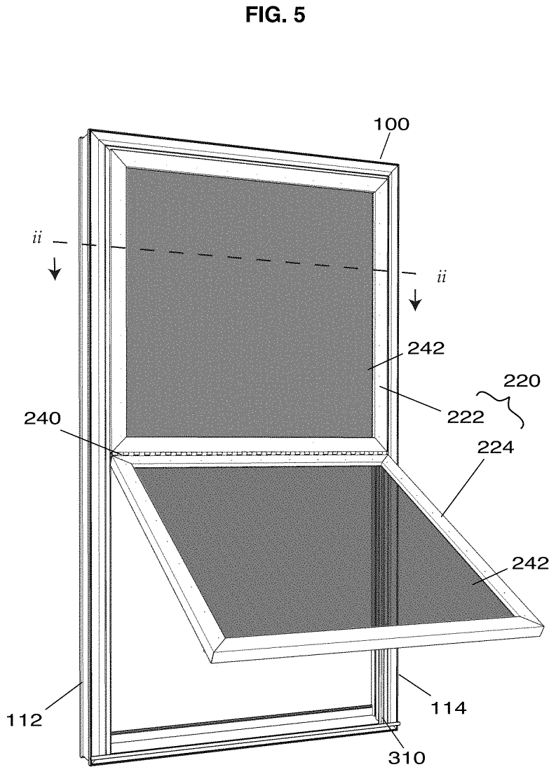

Provided that a window has the necessary integral screen track 120, installation of security screens 200 on double-hung windows according to the method of the present invention may be done in the field after window installation, or alternatively can be done at the factory during window manufacture. Installation of security screens at the factory during window manufacture is another advantage of the present invention, and can greatly simplify installation at the construction site when compared to installing windows and security screens as separate steps. While installing security screens according to the embodiment of the invention illustrated in FIGS. 1-3 may be performed in the field on single-hung windows provided they have the necessary integral screen track, installing security screens according to the embodiment of the invention illustrated in FIGS. 4-6 on a single-hung window would be very difficult to do in the field, so it is preferred that installation on single-hung windows of security screens according to the embodiment of the invention illustrated in FIGS. 4-6 be done at the factory during window manufacture. For clarity of illustration, only the window frame 100 is illustrated, and the sashes of the window being protected are not shown. FIG. 5 is an assembled oblique front elevation view of a hinged security screen in open position illustrating a mounting method according to an embodiment of the invention. According to an embodiment of the invention, for windows having an integral screen track 120 as part of the window frame 100, which would include most double-hung windows, a security screen 200 having a connecting hinge 240 can be sized to fit between the integral screen track 120 in the left jamb 112 and the integral screen track 120 in the right jamb 114. The security screen 200 according to the present invention is smaller in size than prior art security screens relative to the window to be protected and the mounting method according to the present invention does not require a mounting flange, reducing materials requirements for construction and manufacture of the security screen 200. In an exemplary embodiment, as shown, two screen panels 220 are joined by a horizontal connecting hinge 240. A plurality of mounting rails 310, sized and configured to fit within the integral screen track 120 of the window frame 100 are inserted in the integral screen track 120 and sized to the length of a portion of the integral screen track 120, such as the length of the integral screen track 120 of the left jamb 112 and the integral screen track 120 of the right jamb 114. A fixed screen panel 222 is attached to the plurality of mounting rails 310 using fasteners 400, such as screws, and in a preferred embodiment the screws are self-tapping screws which are inserted into pre-drilled holes in the fixed screen panel 222 and driven into the mounting rails 310. It should be noted that the plurality of mounting rails 310 inserted in the integral screen track 120 of the window frame 100 are not attached to the window frame 100, but are held in place by their attachment to the fixed screen panel 222. A working screen panel 224 is pivotably mounted to the fixed screen panel 222 by a connecting hinge 240, or other pivoting attachment means.

The mounting rails 310 may be made of any suitable rigid material, such as metal, wood, polymer or composite materials, and in a preferred embodiment are metal tubing having a substantially rectangular cross section, such as aluminum tubing. Although four-sided hollow rectangular tubing is shown as the mounting rails 310, “U”-channel or solid bar stock may also be used, and bolts or machine screws could be used for the fasteners 400 attaching the fixed screen panel 222 to mounting rails 310 having threaded holes. In the exemplary embodiment shown, the mounting rails 310 run the full lengths of the integral screen track 120 of the left jamb 112 and the integral screen track 120 of the right jamb 114, supporting the fixed screen panel 222 and preventing it from sliding downward along with the mounting rails 310, which it might do if the mounting rails 310 were shorter, or only the same length as the sides of the fixed screen panel 222. Optionally, a mounting rail 310 (not shown) sized and configured to fit within the integral screen track 120 of the header 110 of the window and sized to the length of the integral screen track 120 of the header 110 may be used, if desired, and can provide additional strength to the installation. If desired, a bead of construction adhesive may be applied to the plurality of mounting rails 310 prior to installation in the integral screen track to further strengthen the installation. In a preferred embodiment, the screen panels 220 of the security screen 200 are pre-attached to the connecting hinge 240, and the fixed screen panel 222 pre-drilled to accept the fasteners 400. For clarity of illustration, only the window frame 100 is illustrated, and the sashes of the window being protected are not shown.

FIG. 6 is an assembled cross-sectional plan view of the hinged security screen of FIG. 5 sectioned along line ii-ii and illustrating a mounting method according to an embodiment of the invention. In a preferred embodiment, the screen panels 220 are made of metal, such as extruded aluminum, and the connecting hinge is a steel piano hinge. As known in the art, screen retaining strips 244 may be used to attach the screen 242 to the screen panels 220, and the screen panels may include weatherstripping 246 on the side contacting the window frame 100. In a preferred embodiment, most of the visible parts, including the screen panels 220, screen connecting hinge 240, and screen 242 are powder-coated for appearance and durability.

Although the invention has been shown and described with reference to certain specific presently preferred embodiments, the given embodiments should not be construed as limitations on the scope of the invention, but as illustrative examples, and those skilled in the art to which this invention pertains will undoubtedly find alternative embodiments obvious after reading this disclosure. With this in mind, the following claims are intended to define the scope of protection to be afforded the inventor, and these claims shall be deemed to include equivalent constructions insofar as they do not depart from the spirit and scope of the present invention.

We claim:

1. A system for mounting a security screen to a window frame, said window frame having frame members consisting of a header, a left jamb, a right jamb, and a sill, said window frame having in an exterior portion of each of at least two opposed frame members of said window frame an integral screen track having a depth, the system comprising a security screen, a plurality of mounting rails configured to fit within said integral screen track of said each of at least two opposed frame members, and an attachment means to attach said security screen to said plurality of mounting rails.

2. The system of claim 1, wherein said at least two opposed frame members of said window frame are the left jamb and the right jamb, and at least two of said plurality of mounting rails are configured to fit within said integral screen track of the left jamb and the right jamb of said window frame, and wherein said security screen is configured to fit between said at least two of said plurality of mounting rails.

3. The system of claim 1, wherein said at least two opposed frame members of said window frame are the left jamb and the right jamb, and at least two of the said plurality of mounting rails are configured to fit within said integral screen track of the left jamb and the right jamb of said window frame, and wherein each of said plurality of mounting rails has an exterior-facing surface and a width greater than the depth of said integral screen track, and said security screen is attached to said exterior-facing surface of said plurality of mounting rails by said attachment means.

4. The system of claim 2, wherein the header of said window frame has in an exterior portion thereof an integral screen track, the system further comprising at least one mounting rail disposed within said integral screen track of the header of said window frame.

5. The system of claim 3, wherein the header of said window frame has in an exterior portion thereof an integral screen track, the system further comprising at least one mounting rail disposed within said integral screen track of the header of said window frame.

6. The system of claim 2, wherein the attachment means comprises screws.

7. The system of claim 2, wherein each of said plurality of mounting rails further comprises at least one threaded hole, and the attachment means comprises bolts.

8. The system of claim 3, wherein the attachment means comprises screws.

9. The system of claim 3, wherein each of said plurality of mounting rails further comprises at least one threaded hole, and the attachment means comprises bolts.

10. The system of claim 5, wherein the ends of said at least one mounting rail disposed within said integral screen track of the header of said window frame extend into said integral screen track of the left and right jambs of said window frame, and are positioned above and supported by said at least two of said plurality of mounting rails opposingly disposed within said integral screen track of the left and right jambs of said window frame.

11. The system of claim 10, wherein the plurality of mounting rails further comprises at least one mounting rail disposed across the sill of said window frame, the ends of said at least one mounting rail disposed across the sill of said window frame extending into said integral screen track of the left and right jambs of said window frame, and positioned below and supporting said at least two of said plurality of mounting rails opposingly disposed within said integral screen track of the left and right jambs of said window frame.

12. The system of claim 2, wherein the security screen comprises a first screen panel attached by said attachment means to said at least two of the said plurality of mounting rails opposingly disposed within said integral screen track of the left and right jambs of said window frame.

13. The system of claim 12, wherein the security screen further comprises a second screen panel attached to said first security screen by a pivotable mounting means.

14. The system of claim 13, wherein the pivotable mounting means comprises a connecting hinge and screws attaching said connecting hinge to said first screen panel and said second screen panel.

15. The system of claim 14, wherein said second screen panel further comprises a latching means configured to reversibly secure said second screen panel to said window frame.

16. The system of claim 3, wherein the security screen comprises a first screen panel attached by said attachment means to said at least two of said plurality of mounting rails opposingly disposed within said integral screen track of the left and right jambs of said window frame.

17. The system of claim 16, wherein the security screen further comprises a second screen panel attached to said first screen panel by a pivotable mounting means.

18. The system of claim 17, wherein the pivotable mounting means comprises a connecting hinge and screws attaching said connecting hinge to said first screen panel and said second screen panel, and wherein said second screen panel further comprises a latching means configured to reversibly secure said second screen panel to said window frame.

19. A system for mounting a security screen to a window frame, said window frame having frame members consisting of a header, a left jamb, a right jamb, and a sill, said window frame having in an exterior portion of each of at least two opposed frame members of said window frame an integral screen track, the system comprising a plurality of mounting rails configured to fit within said integral screen track of said each of at least two opposed frame members, a security screen comprising a first screen panel and a second screen panel joined by a pivotable mounting means, said security screen configured to fit between said plurality of mounting rails, and an attachment means to attach said first screen panel of said security screen to said plurality of mounting rails.

20. A system for mounting a security screen to a window frame, said window frame having frame members consisting of a header, a left jamb, a right jamb, and a sill, said window frame having in an exterior portion of each of at least two opposed frame members of said window frame an integral screen track having a depth, the system comprising a plurality of mounting rails configured to fit within said integral screen track of said each of at least two opposed frame members, each of said plurality of mounting rails having an exterior-facing surface and a width greater than the depth of said integral screen track, a security screen comprising a first screen panel and a second screen panel joined by a pivotable mounting means, and an attachment means to attach said first screen panel of said security screen to said exterior-facing surface of said plurality of mounting rails.
